(19) United States
(12) Patent Application Publication
(10) Pub. No.: US 2025/0167956 A1
(43) Pub. Date: May 22, 2025

(54) METHODS AND APPARATUS FOR REDUCED CAPACITY USER EQUIPMENT POSITIONING

(71) Applicant: MediaTek Singapore Pte. Ltd., Singapore (SG)

(72) Inventors: Pengli YANG, Shanghai (CN); Chiao-Yao CHUANG, Hsinchu City (TW); Jijian CHEN, Shanghai (CN); Xuancheng ZHU, Shanghai (CN); Xiao LIANG, Shanghai (CN)

(21) Appl. No.: 18/840,646

(22) PCT Filed: Apr. 26, 2023
(86) PCT No.: PCT/CN2023/090964

§ 371 Date: Aug. 22, 2024

(30) Foreign Application Priority Data
Apr. 28, 2022 (WO) PCT/CN2022/089983
Apr. 29, 2022 (WO) PCT/CN2022/090493

(51) Int. Cl. H04L 5/00; H04W 8/24

(52) U.S. Cl. CPC H04L 5/0051; H04L 5/0064; H04W 8/24; H04L 5/0007

(57) ABSTRACT

Apparatus and methods are provided RedCap UE positioning procedures. In one novel aspect, the UE with limited bandwidth obtains SRS configuration for multiple UL SRS resources and transmits the UL SRS with frequency hopping. In one embodiment, the UE receives capability request from the network, reports a UE RF retuning time in a UE capability response, receives an SRS configuration with multiple transmissions within an SRS duration, which is based on the UE RF retuning time, and performs an UL SRS transmission based on the SRS configuration. In one embodiment, the UE receives the higher layer parameters for uplink SRS configuration, including the spatial information, frequency, and time location information. In another embodiment, the UE with smaller bandwidth transmits the SRS by frequency hopping manner. The SRS transmissions in different time instances have different frequency positions by RF re-tuning.

### TECHNICAL FIELD

The disclosed embodiments relate generally to wireless communication, and, more particularly, to methods and apparatus for reduced capacity (RedCap) user equipment (UE) positioning.

### BACKGROUND

Mobile networks communication continues to grow rapidly. The mobile data usage will continue skyrocketing. New data applications and services, which have different bandwidth requirements, will require higher speed and more efficient. To address the increasing burden on network traffic and to ensure a better quality of service for all users, Reduced Capacity User Equipment (RedCap UE) has been developed. A RedCap UE has the limited maximum bandwidth for downlink (DL) and uplink (UL). While RedCap UE offers broad ranges of advantages, its limited bandwidth affects its performance when it cannot take advantage of services/functions offered with large bandwidth.

Positioning reference signal (PRS) and sounding reference signal (SRS) are used by UEs to acquire synchronization and channel state information from the base station PRS is a periodic signal that is transmitted by the base station, and SRS is a signal that is transmitted by the UE. Both PRS and SRS are used to estimate the channel between the UE and the base station. PRS with large bandwidth enables the UE to improve measurement accuracy and maintain system RS overhead. SRS with large bandwidth improves the accuracy of uplink measurements.

Improvements and enhancements are required to assist the RedCap UE to leverage the large bandwidth of PRS and/or SRS for improving measurement accuracy and to maintain the system RS overhead.

### SUMMARY

Apparatus and methods are provided RedCap UE positioning procedures. In one novel aspect, the UE with limited bandwidth is configured with multiple PRS resources and performs frequency hopping for PRS measurement over a large bandwidth. In one embodiment, the UE receives the higher layer assistance information of one or more positioning frequency layers for downlink PRS configuration, including the spatial information and frequency position of each PRS resource. In another embodiment, the PRS resources are transmitted from BS with two bandwidth types, larger-bandwidth PRS transmission and larger-bandwidth PRS transmission in conjunction with smaller-bandwidth. The smaller-bandwidth PRS transmissions with different frequency layers maybe overlapped partially in frequency domain. In yet another embodiment, the UE receives PRS resources of across positioning frequency layers indicated with the associated spatial transmission filter or indicated with the QCL relation between resources. In one embodiment, the UE receives PRS resources with a larger bandwidth as compared to the limited reception bandwidth after combining the received bandwidth in different frequency position by RF retuning.

In another novel aspect, the UE with limited bandwidth obtains SRS configuration for multiple UL SRS resources and transmits the UL SRS with frequency hopping. In one embodiment, the UE receives capability request from the network, reports a UE RF retuning time in a UE capability response, receives an SRS configuration with multiple transmissions within an SRS duration, which is based on the UE RF retuning time, and performs an UL SRS transmission based on the SRS configuration. In one embodiment, the UE receives the higher layer parameters for uplink SRS configuration, including the spatial information, frequency, and time location information. In another embodiment, the UE with smaller bandwidth transmits the SRS by frequency hopping manner. The SRS transmissions in different time instances have different frequency positions by RF re-tuning. Partial overlapping BW in frequency domain is configured between two SRS transmissions to allow the receiver to estimate phase change. In one embodiment, the SRS frequency exceeds UE's uplink bandwidth part (BWP) during the hopping cycle, and the network defines a period of time for UE to transmit outside BWP. To complete a hopping cycle, the period of time includes the RF retuning time back to original uplink BWP. In one embodiment, the SRS configuration further comprises the spatial relation across several transmissions, the transmissions may be associated to a same downlink RS or an SRS resource for the spatial relation measurement. In yet another embodiment, the SRS frequency hopping is performed by intra-slot hopping, inter-slot hopping or a hybrid of inter-slot hopping and intra-slot hopping. The SRS frequency hopping pattern is based on the number of OFDM symbols within a slot of each SRS transmission.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with large-bandwidth PRS and SRS configured and RedCap UEs with improved PRS and SRS procedures.

FIG. 2 illustrates exemplary diagrams for a RedCap UE to perform reception bandwidth hopping to observe larger PRS bandwidth with sufficient repetition numbers in accordance with embodiments of the current invention.

FIG. 3 illustrates exemplary diagrams for a RedCap UE to perform reception bandwidth hopping to observe larger PRS bandwidth with insufficient repetition numbers in accordance with embodiments of the current invention.

FIG. 4 illustrates exemplary diagrams for starting PRB index calculation for each positioning frequency layer when the starting PRB index increases with time instance in accordance with embodiments of the current invention.

FIG. 5 illustrates exemplary diagrams for starting PRB index calculation for each positioning frequency layer when the starting PRB index decreases with time instance in accordance with embodiments of the current invention.

FIG. 6 illustrates exemplary diagrams for PRS hopping together with existing transmission pattern that is sweeping after repetition in accordance with embodiments of the current invention.

FIG. 7 illustrates exemplary diagrams for PRS hopping together with existing transmission pattern that is repetition after sweeping in accordance with embodiments of the current invention.

FIG. 8 illustrates exemplary diagrams of a UE with limited transmission bandwidth to perform transmission bandwidth hopping within and outside BWP when transmission BW is the same as UE's uplink BWP BW in accordance with embodiments of the current invention.

FIG. 9 illustrates exemplary diagrams of a UE with limited transmission bandwidth to perform transmission bandwidth hopping within and outside BWP when transmission BW is different from the UE's uplink BWP BW in accordance with embodiments of the current invention.

FIG. 10 illustrates exemplary diagrams of a UE with limited transmission bandwidth to perform transmission bandwidth hopping within and outside BWP when the first frequency position is different from the frequency position of the uplink BWP in accordance with embodiments of the current invention.

FIG. 11 illustrates exemplary diagrams of a UE with limited transmission bandwidth performing transmission hopping with different hopping configurations in accordance with embodiments of the current invention.

FIG. 12 illustrates an exemplary flow chart for the RedCap UE to perform SRS with frequency hopping for large bandwidth PRS in accordance with embodiments of the current invention.

FIG. 13 illustrates an exemplary flow chart for the base station to configure and transmit PRS for RedCap UE for large bandwidth PRS in accordance with embodiments of the current invention.

### DETAILED DESCRIPTION

Reference will now be made in detail to some embodiments of the invention, examples of which are illustrated in the accompanying drawings.

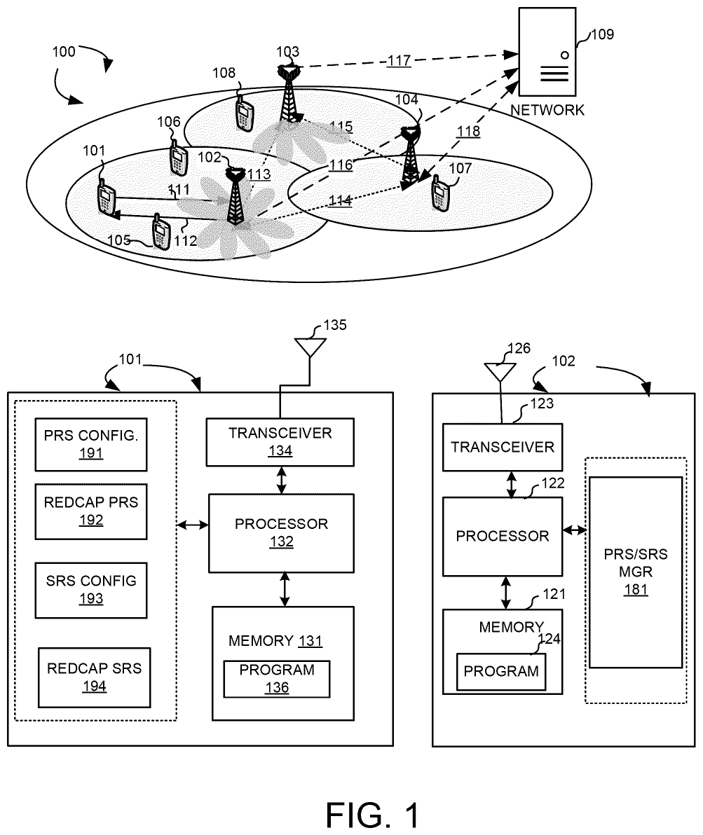

FIG. 1 illustrates a system diagram of a wireless network with large-bandwidth PRS and SRS configured and RedCap UEs with improved PRS and SRS procedures. Wireless communication system 100 includes one or more wireless networks each of the wireless communication network has fixed base infrastructure units, such as receiving wireless communications devices or base unit 102 103, and 104, forming wireless networks distributed over a geographical region. The base unit may also be referred to as an access point, an access terminal, a base station, a Node-B, an eNode-B, a gNB, or by other terminology used in the art. Each of the base unit 102, 103, and 104 serves a geographic area. Backhaul connections 113, 114 and 115 connect the non-co-located receiving base units, such as 102, 103, and 104. These backhaul connections can be either ideal or non-ideal

A wireless communications device 101 in wireless network 100 is served by base station 102 via uplink 111 and downlink 112. Other UEs 105, 106, 107, and 108 are served by different base stations. UEs 105 and 106 are served by base station 102. UE 107 is served by base station 104. UE 108 is served by base station 103. The base stations, such as 102, 103, and 104 may also be multi-beam base stations. A network entity, such as network entity 109 is connected with base stations such as base station 102, 103, and 104, via links of 116, 117, and 118. Network entity 109 of the core network can be a location management (LMF). In one embodiment, the LMF of the core network requests the UE capability, receives the UE capability response with the UE RF retuning time and sends a sound reference signal (SRS) configuration to the UE. In one embodiment, the LMF of the core network performs all or part of the functions of the base station for UE positioning procedures.

FIG. 1 further shows simplified block diagrams of wireless device/UE 101 and base station 102 in accordance with the current invention.

Base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as a PRS/SRS management module 181 that configures PRS/SRS and communicates with UEs. The base station control module 181 is further configured to configure multiple downlink (DL) multiple position reference signal (PRS) resources for a user equipment (UE) for a PRS with a PRS bandwidth, wherein the UE is a reduced capacity UE that has a reception bandwidth smaller than the PRS bandwidth, and wherein each PRS resources has a bandwidth within the reception bandwidth of the UE, transmit a DL PRS configuration for the PRS to the UE, wherein the DL PRS configuration includes the multiple PRS resources and one or more frequency layers, and wherein each frequency layer is associated with a corresponding starting PRB index, transmit a first PRS on a first PRS resource at a baseband of the UE with a starting frequency position being a first frequency position, and transmit one or more subsequent PRS on one or more corresponding PRS resource based on the DL PRS configuration.

UE 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

UE 101 also includes a set of control modules that carry out functional tasks. These functions can be implemented in software, firmware and hardware. A configuration module 191 receives DL PRS configuration with a PRS bandwidth, wherein the UE is a reduced capacity UE that has a reception bandwidth smaller than the PRS bandwidth, and wherein the DL PRS configuration includes multiple PRS resources each within the reception bandwidth and one or more frequency layers, and wherein each frequency layer is associated with a corresponding starting PRB index. A RedCap PRS module 192 performs a first PRS measurement on a first PRS resource at a baseband of the UE with a starting frequency position being a first frequency position, performs one or more subsequent PRS measurements on one or more corresponding PRS resources based on the PRS configuration, wherein each subsequent PRS measurement is performed by adjusting the starting frequency position to a new corresponding frequency position based on the PRS configuration, and calculates a PRS result based on the first PRS measurement and the one or more subsequent PRS measurements. An SRS configuration module 193 obtains sounding reference signal (SRS) configuration for uplink (UL) SRS positioning, wherein the UE is a reduced capacity UE that has a UL bandwidth parts (BWP) bandwidth smaller than a system bandwidth for UL SRS, and wherein the SRS configuration includes multiple SRS resources each with a transmission bandwidth smaller than the system bandwidth and different frequency positions. A RedCap SRS module 194 transmits a first SRS with a first SRS resource on a first frequency position and transmits one or more subsequent SRSs on one or more corresponding SRS resources based on the SRS configuration, wherein each subsequent SRS transmission is performed by adjusting a frequency position.

In one novel aspect, frequency hopping is used for the RedCap UE to receive PRS with bandwidth larger than the reception bandwidth of the UE. A positioning frequency layer consists of one or more PRS resource sets. The positioning frequency layer is defined with corresponding subcarrier spacing, cyclic prefix and the absolute frequency of a reference point, namely, frequency reference point-A. A PRS resource set defines a same bandwidth for the associated PRS resources. Further, all the PRS resource sets within a same positioning frequency layer have the same bandwidth. A PRS resource set defines a same starting PRB index with respect to the point A for the associated PRS resources. Further, all the PRS resource sets within a same positioning frequency layer have the same starting PRB index.

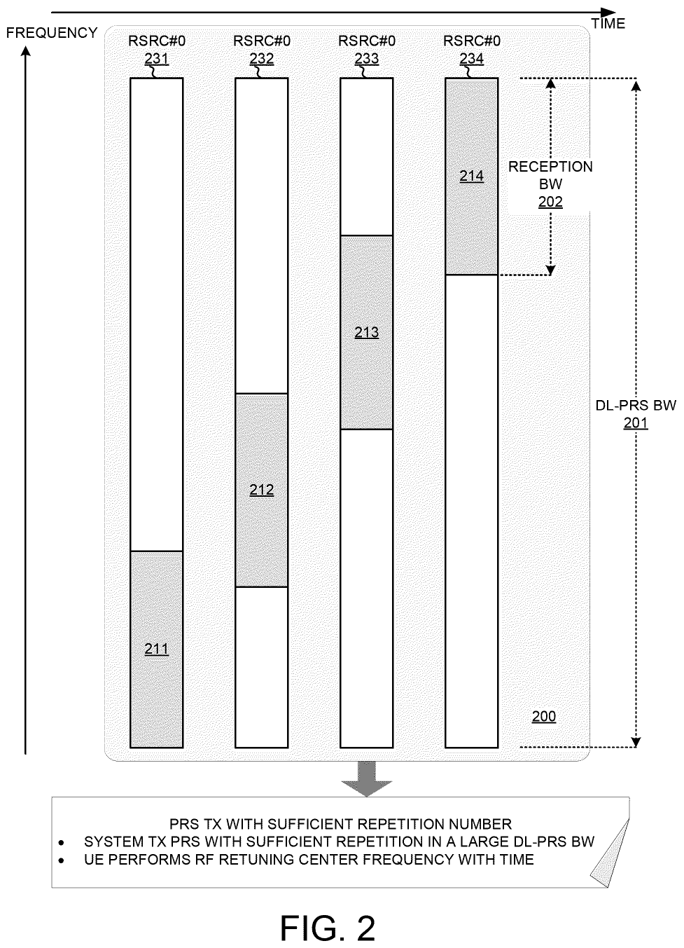

FIG. 2 illustrates exemplary diagrams for a RedCap UE to perform reception bandwidth hopping to observe larger PRS bandwidth with sufficient repetition numbers in accordance with embodiments of the current invention. In one scenario 200, a system with base stations is able to transmit the large-bandwidth PRS with sufficient repetition number such that a UE with limited reception bandwidth may re-tune to change its reception centre frequency with time. As such, the UE may be able to receive with a larger bandwidth as compared to the limited reception bandwidth after combining the received bandwidth in different time instance. A RedCap UE has a reception bandwidth 202, which is smaller than the DL-PRS bandwidth 201. In one scenario, the network is configured to transmit the PRS with PRS BW 201 with repetition via the same resource set #0. The PRS is transmitted repeatedly on resource set #0 at time instances 231, 232, 233, and 234. The large-bandwidth PRS is generally defined to be comparable to the channel bandwidth of a component carrier. The repetition of transmission generally indicates that the transmissions are based on a same spatial transmission filter. Further, for example, the time instance could be in the unit of slot time. In the configuration example of 200, the RedCap UE with reception bandwidth 202 performs frequency hopping and different time instances when the PRS is transmitted repeatedly. UE first preforms PRS measurement 211 with a reception bandwidth of 202. The UE adjusts its starting frequency or centre frequency position and performs a subsequent PRS measurement 212. Similar, subsequent PRS measurements 213 and 214 are performed with resource set #0. When there is sufficient repetition number for the large bandwidth PRS transmission, the UE performs multiple PRS measurement with smaller reception bandwidth on the same resource set by retuning its starting frequency for frequency hopping during the PRS repetition. The UE calculates the PRS result for the large PRS bandwidth based on the multiple PRS measurements, such as PRS measurements 211, 212, 213, and 214.

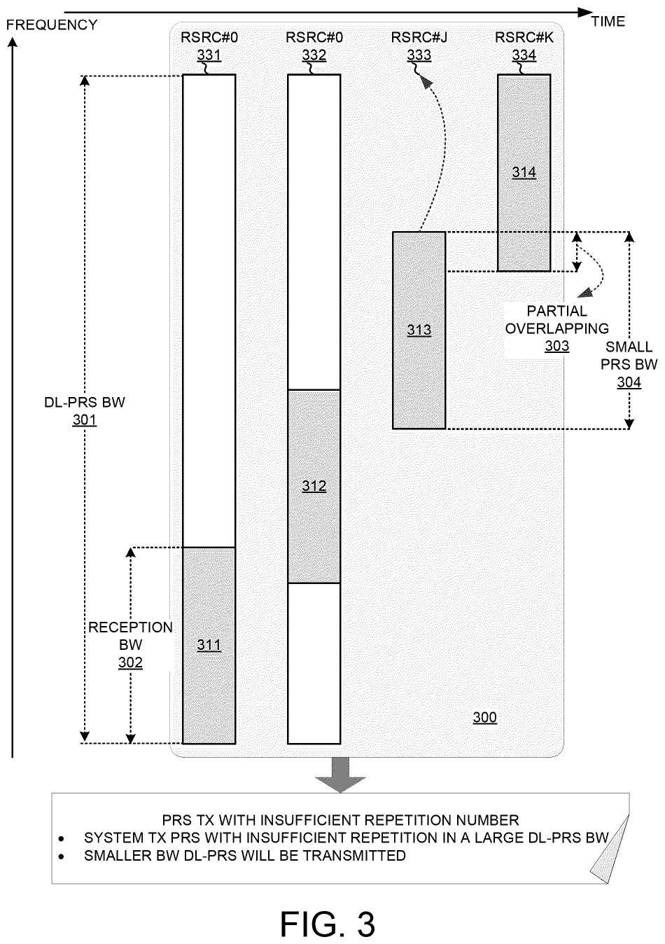

FIG. 3 illustrates exemplary diagrams for a RedCap UE to perform reception bandwidth hopping to observe larger PRS bandwidth with insufficient repetition numbers in accordance with embodiments of the current invention. In one scenario 300, a system with base stations is not able to transmit the large-bandwidth PRS with sufficient repetition number. Resource set #0 are transmitted repeated twice at time instances 331 and 332. The RedCap UE with reception bandwidth 302 cannot perform PRS measurement for the PRS with large PRS bandwidth 301 during the repetition transmission 331 and 332. In one embodiment, when a system with base stations is not able to transmit the larger-bandwidth PRS with sufficient repetition number, the smaller-bandwidth PRS with a different starting PRB index in a different time instance could be transmitted. Resource set #J at time instance 333 with small PRS bandwidth 304 is configured and transmitted by the network. Resource set #K at time instance 334 with small PRS bandwidth is transmitted subsequently. Resource #J and resource #K are partially overlapped (303). The PRS hopping with smaller-bandwidth can reduce the RS overhead compared with larger-bandwidth PRS repetition. As such, the UE may also be able to receive with a larger bandwidth as compared to the limited reception bandwidth after combining the received bandwidth in different time instances. As illustrated, UE performs PRS measurement 311 and 312 on the large-bandwidth PRS with repetition and performs PRS measurement 313 and 314 on small-bandwidth PRS. The UE calculates a PRS result based on the PRS measurements of 311, 312, 313, and 314. The smaller-bandwidth PRS is generally defined to be comparable to the maximum reception bandwidth of RedCap UEs, and the maximum reception bandwidth of RedCap UEs is generally smaller than the channel bandwidth of a component carrier.

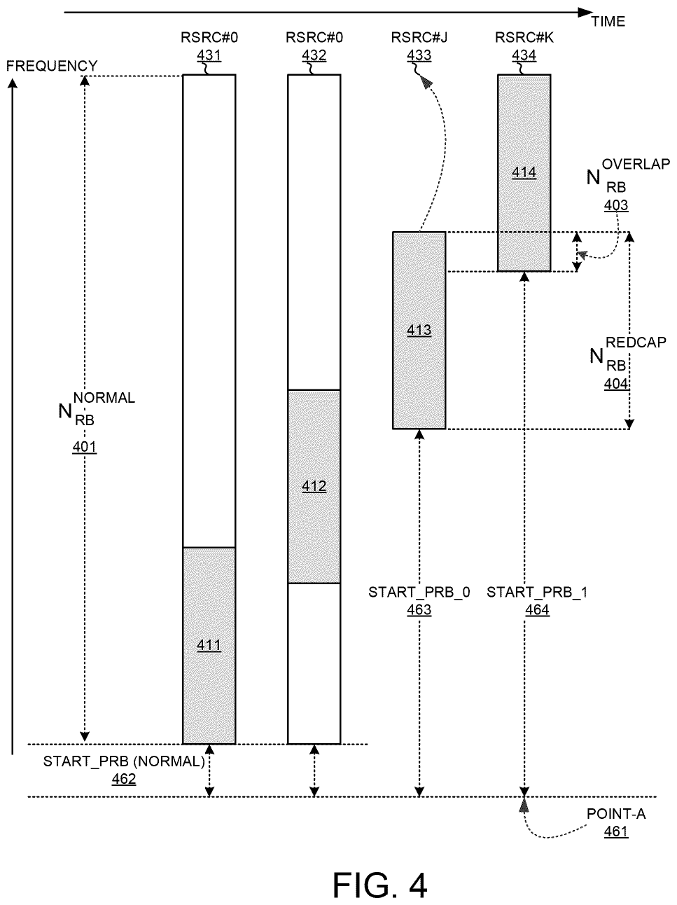

FIG. 4 illustrates exemplary diagrams for starting PRB index calculation for each positioning frequency layer when the starting PRB index increases with time instance in accordance with embodiments of the current invention. In one embodiment, the PRS configuration includes multiple PRB resources. Each of the PRB resource has a bandwidth within the reception bandwidth of the RedCap UE. One or more frequency layers are configured. Each of the frequency layer is configured with a starting PRB index. The PRB index is a distance from a reference frequency, the point-A 461. The starting PRB index for a n^{th} frequency layer is based on a (n−1)th starting PRB index for a time-domain neighboring (n−1)th frequency layer, an overlapping bandwidth between the nth frequency layer and the (n−1)th frequency layer, and a transmission bandwidth, which is within the reception bandwidth of the UE, for the nth frequency layer.

As illustrated, the PRS configuration includes at time instance 431 and 432, two large-bandwidth repeatedly transmitted PRS resources #0, with bandwidth 401. For the RedCap UE with a reception bandwidth smaller than the large PRS bandwidth 401, there is insufficient repetition of the large-bandwidth PRS. Two small bandwidth PRS resources, with reduced bandwidth 404, are configured at time instances 433, with resource #J, and at time instance 434 with resource #K. In one embodiment, different frequency layers are configured for PRS resource #0, #J and #K. The UE performs PRS measurements with PRS resource 411, 412, 413, and 414 at time instances 431, 432, 433, and 434, respectively. For the PRS transmitted with the normal large PRS bandwidth, the PRS resource is configured with PRB index of startPRB(normal) 462, which is the distance between point-A 461 and the starting frequency of the RSRC #0.

In particular, the starting PRB index, which increases with the time instance, associated to the small bandwidth transmission is determined by

$${startPRB}_{n} = {startPRB}_{n - 1} + ( {N}_{RB}^{RedCap} - {N}_{RB}^{overlap} )$$

where N_{RB}^{RedCap} 404 denotes the small transmission BW, N_{RB}^{overlap} 403 is the partial overlapping BW between two PRS transmissions in adjacent time instances. N_{RB}^{overlap}=4i, i=0, 1, 2, . . . n is the positioning frequency layer transmission number. startPRB₀ 463 is the first starting frequency position of the PRS transmission for hopping, means the starting PRB index of the first small bandwidth PRS transmission. startPRB₁ 464 is the second/subsequent starting frequency position of the small bandwidth PRS transmission. Further, as illustrated, when the smaller-bandwidth PRS (413 and 414) is transmitted in conjunction with larger-bandwidth PRS (411, and 412), the first starting PRB index, which increases with the time instance, of the small bandwidth transmission for hopping is determined by

$${startPRB}_{0} = {startPRB}_{normal} + ( {N}_{RB}^{RedCap} - {N}_{RB}^{overlap} ) * {N}^{rep}$$

where N^{rep} denotes the repetition factor for the larger-bandwidth PRS transmission, N_{RB}^{normal} 401 denotes the large PRS transmission BW, startPRBₙₒᵣₘₐₗ 462 denotes the starting PRB index of the large PRS BW transmission. The N^{rep} as illustrated is two. When there is no small-bandwidth PRS configured, as illustrated in FIG. 2, there is only one positioning frequency layer which contains resource #0 with the repetition factor is four (N^{rep}=4), and there is one starting PRB index. The smaller-bandwidth PRS transmission with a different starting PRB index in frequency domain in a different time instance could be treated as the PRS transmission in a different positioning frequency layer, since the PRS resources and resource sets within a positioning frequency layer have the same starting PRB index and bandwidth. Further, the PRS resources of across positioning frequency layers may be indicated with the associated spatial transmission filter or be indicated with the QCL relation between resources.

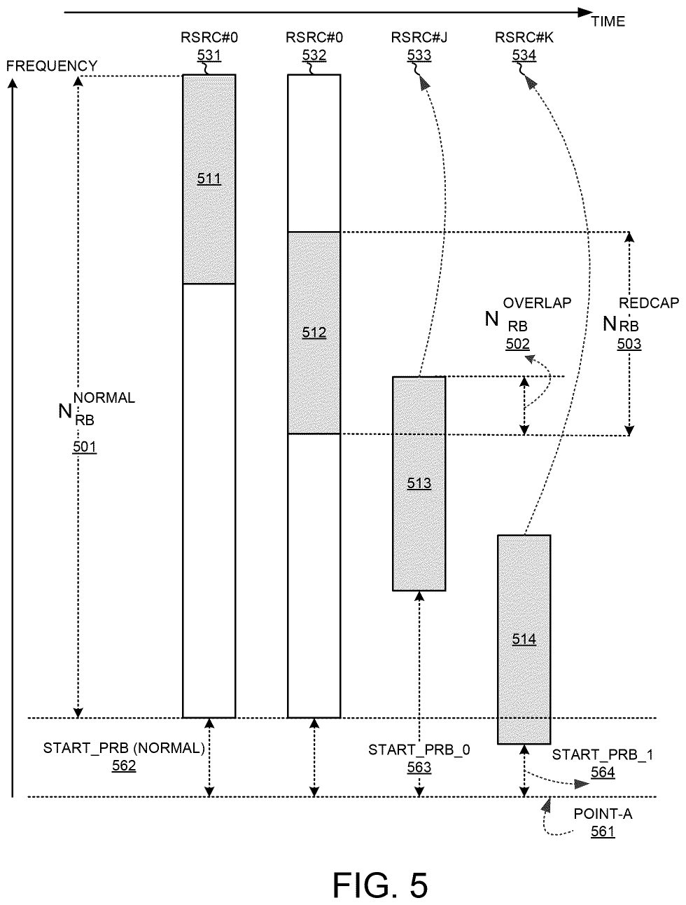

FIG. 5 illustrates exemplary diagrams for starting PRB index calculation for each positioning frequency layer when the starting PRB index decreases with time instance in accordance with embodiments of the current invention. As illustrated, the PRS configuration includes at time instance 531 and 532, two large bandwidth repeatedly transmitted PRS resources #0, with bandwidth 501. For the RedCap UE with a reception bandwidth smaller than the large PRS bandwidth 501, there is insufficient repetition of the large-bandwidth PRS. Two small bandwidth PRS resources, with reduced bandwidth 503, are configured at time instances 533, with resource #J, and at time instance 534 with resource #K. In one embodiment, different frequency layers are configured for PRS resource #0, #J and #K. The UE performs PRS measurements with PRS resource 511, 512, 513, and 514 at time instances 531, 532, 533, and 534, respectively. The PRB index is a distance from a reference frequency, the point-A 561. For the PRS transmitted with the normal large PRS bandwidth, the PRS resource is configured with PRB index of startPRB(normal) 562, which is the distance between point-A 561 and the starting frequency of the RSRC #0.

In particular, the starting PRB index, which decreases with the time instance, associated to the small bandwidth transmission is determined by

$${startPRB}_{n} = {startPRB}_{n - 1} - ( {N}_{RB}^{RedCap} - {N}_{RB}^{overlap} )$$

where N_{RB}^{Redcap} 503 denotes the small transmission BW, N_{RB}^{overlap} 502 is the partial overlapping BW between two PRS transmissions in adjacent time instances. N_{RB}^{overlap}=4i, i=0, 1, 2, . . . n is the positioning frequency layer transmission number. startPRB₀ 563 is the first starting frequency position of the PRS transmission for hopping, means the starting PRB index of the first small bandwidth PRS transmission. startPRB₁ 564 is the second/subsequent starting frequency position of the small bandwidth PRS transmission. Further, as illustrated, when the smaller-bandwidth PRS (513 and 514) is transmitted in conjunction with larger-bandwidth PRS (511, and 512), the first starting PRB index, which decreases with the time instance, of the small bandwidth transmission for hopping is determined by:

$${startPRB}_{0} = {startPRB}_{normal} + {N}_{RB}^{normal} - {N}_{RB}^{RedCap} - ( {N}_{RB}^{RedCap} - {N}_{RB}^{overlap} ) * {N}^{rep}$$

where N^{rep} denotes the repetition factor for the larger-bandwidth PRS transmission, N_{RB}^{normal} 501 denotes the large PRS transmission BW, startPRBₙₒᵣₘₐₗ 562 denotes the starting PRB index of the large PRS BW transmission. The N^{rep} as illustrated is two.

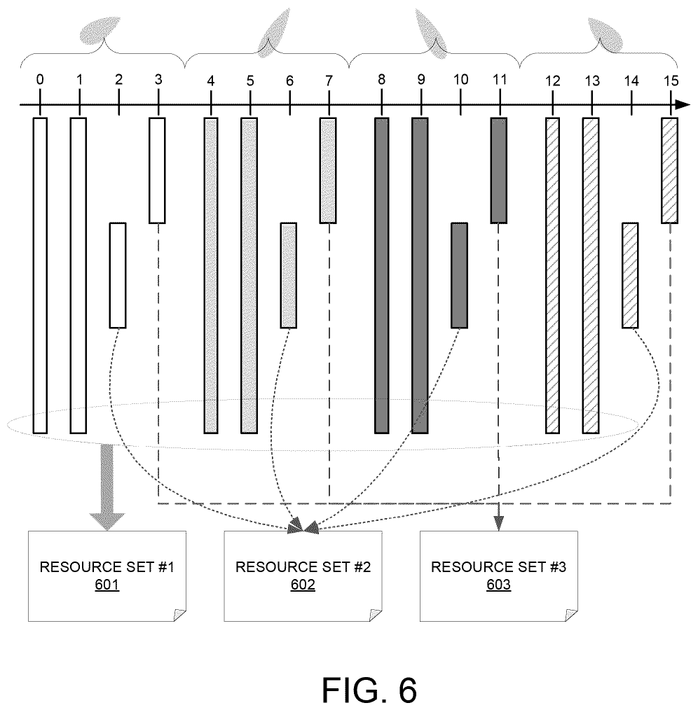

FIG. 6 illustrates exemplary diagrams for PRS hopping together with existing transmission pattern that is sweeping after repetition in accordance with embodiments of the current invention. The resource slot offset in each time instance and QCL relation between resources are also illustrated. In this example, one resource set, resource set #1 601, with large BW is for the normal UE. The system can additionally allocate two more resource sets, resource set #2 602 and resource set #3 603, with different startPRB to facilitate RedCap UE for obtaining larger PRS BW. Resource set #1 601 includes resources at time slot offset #0, #4, #8, #12, #1, #5, #9, and #13. Resource set #2 602 includes resources at time slot offset #2, #6, #10, and #14. Resource set #3 603 includes resources at time slot offset #3, #7, #11, and #15. For UE reception, these resources at time instance #0, #1, #2, #3 are QCL typeD with each other, due to being associated with same spatial transmission filter. Similar QCL relation between resources in instance #4, #5, #7, or between resources in instance #8, #9, #10, #11, or between resources in instance #12, #13, #14, #15. In one embodiment, the SRS resource set, such as resource set 601, 602 and 603, is configured to be periodic, semi-persistent or aperiodic transmission for the one or more SRS resources.

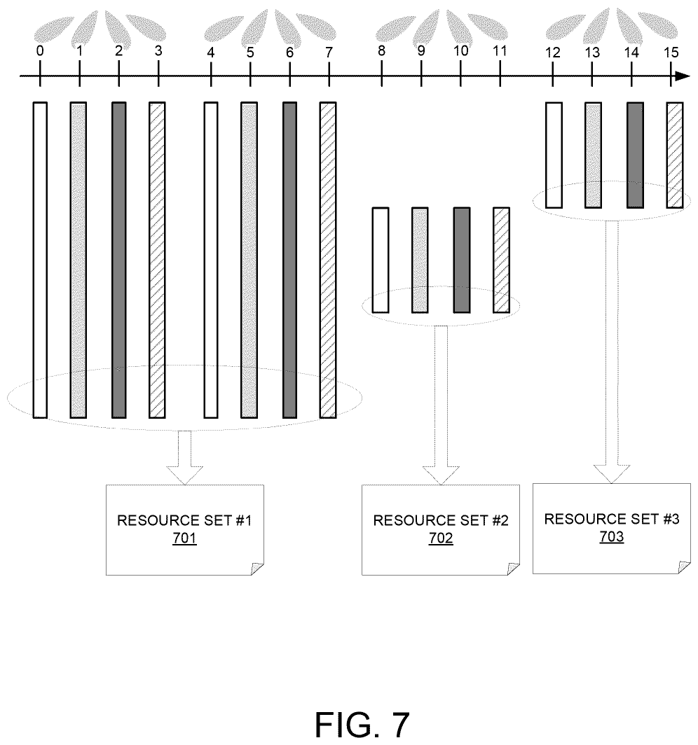

FIG. 7 illustrates exemplary diagrams for PRS hopping together with existing transmission pattern that is repetition after sweeping in accordance with embodiments of the current invention. In this example, one resource set, resource set #1 701, with large BW is for the normal UE. The system can additionally allocate two more resource sets, resource set #2 702 and resource set #3 703, with different startPRB to facilitate RedCap UE for obtaining larger PRS BW. Resource set #1 701 includes resources at time slot offset #0 to #7. Resource set #2 702 includes resources at time slot offset #8 to #11. Resource set #3 703 includes resources at time slot offset #12 to #15. For UE reception, these resources at instance #0, #4, #8, #12 are QCL type D with each other. Similar QCL relation between resources in instance #1, #5, #9, #13, or between resources in instance #2, #6, #10, #14, or between resources in instance #3, #7, #11, #15. In one embodiment, the SRS resource set, such as resource set 701, 702 and 703, is configured to be periodic, semi-persistent or aperiodic transmission for the one or more SRS resources.

In one novel aspect, RedCap UE obtains SRS configuration for UL SRS positioning, wherein the SRS configuration includes multiple SRS resources each with a transmission bandwidth smaller than the system bandwidth and different frequency positions and transmits multiple small-BW SRS with frequency hopping.

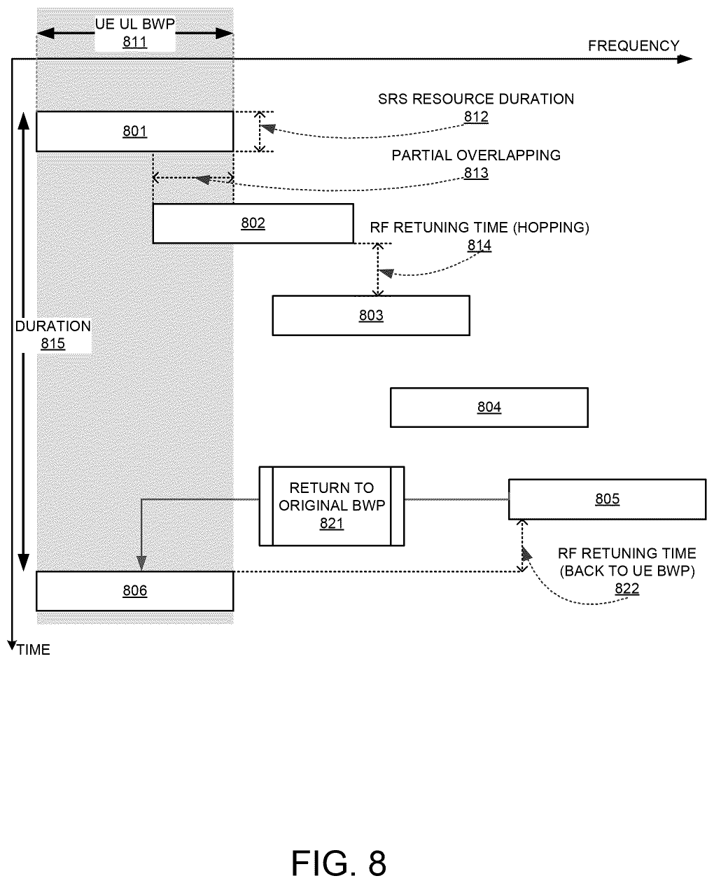

FIG. 8 illustrates exemplary diagrams of a UE with limited transmission bandwidth to perform transmission bandwidth hopping within and outside BWP when transmission BW is the same as UE's uplink BWP BW in accordance with embodiments of the current invention. The RedCap UE has a UE UL BWP 811. To enable the system with base station that can observe SRS resource with larger bandwidth than the UE transmission bandwidth, the UE is configured with multiple SRS resources/hopping transmissions 801, 802, 803 and 804, and performs frequency hopping. The SRS resource can be referred to as hopped transmission for each frequency hopping, or hopping transmission, or a transmission with the hopping duration/SRS duration. There exists partial overlapping BW 813 in frequency domain between two transmissions to allow the system with base station to estimate the phase change due to RF retuning of UE. The SRS transmissions (801, 802, 803, 804, and 805) in different time instances may have different frequency positions (e.g., center frequency, start frequency) by RF re-tuning, with a RF retuning time for hopping 814. Once the UE completes the hopping cycle that covers the large bandwidth of the system, at step 821, the UE returns to the original BWP. The UE performs other transmissions 806 at its original BWP. The SRS frequency hopping will exceed UE's uplink BWP 811 during the hopping cycle. The network defines a period of time (duration 815) for UE to transmit outside BWP. The period of time includes all SRS resource durations and RF retuning time required in a complete hopping cycle, and the RF retuning time include the time (822) back to original uplink BWP.

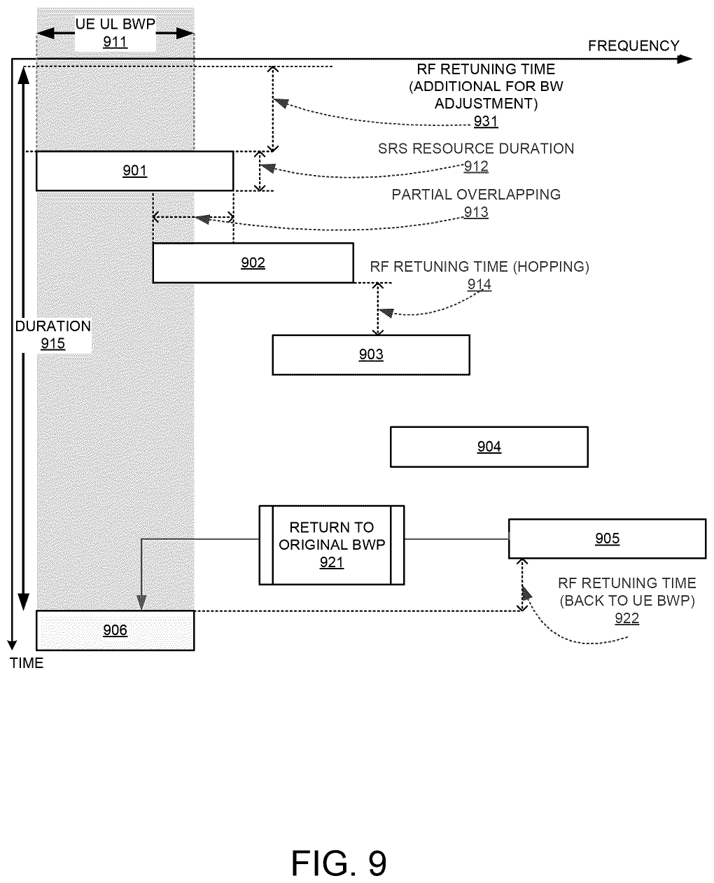

FIG. 9 illustrates exemplary diagrams of a UE with limited transmission bandwidth to perform transmission bandwidth hopping within and outside BWP when transmission BW is different from the UE's uplink BWP BW in accordance with embodiments of the current invention. In one embodiment, the SRS bandwidth from the RedCap UE is configured with a different size than the UE UL BWP. The UE has a UE UL BWP 911. Multiple SRS resources, with SRS resource duration 912 are configured with size different than the UE UL BWP 911. The UE is configured with multiple SRS resources and performs frequency hopping 901, 902, 903 904 and 905, each has an SRS resource with bandwidth larger than the UE UL BWP 911. There exists partial overlapping BW 913 in frequency domain between two transmissions to allow the system with base station to estimate the phase change due to RF retuning of UE. The SRS transmissions (901, 902, 903, and 904) in different time instances may have different frequency positions (e.g., center frequency, start frequency) by RF re-tuning, with a RF retuning time for hopping 914. In one embodiment, additional RF retuning time 931 is added at the start of the SRS transmission when the SRS bandwidth is different from the UE UL BWP 911. Once the UE completes the hopping cycle that covers the large bandwidth of the system, at step 921, the UE returns to the original BWP. The UE performs other transmissions 906 at its original BWP. The SRS frequency hopping will exceed UE's uplink BWP 911 during the hopping cycle. The network defines a period of time (duration 915) for UE to transmit outside BWP. The period of time includes all SRS resource durations and RF retuning time required in a complete hopping cycle, and the RF retuning time include the time (922) back to original uplink BWP. In one embodiment, duration 915 further includes the additional RF retuning time in the beginning to adjust the bandwidth.

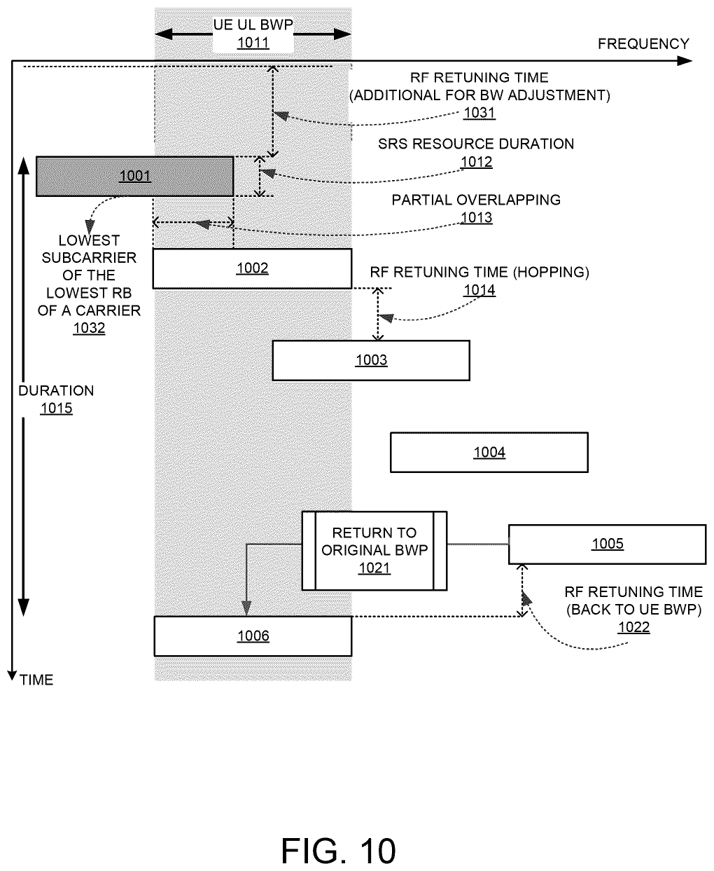

FIG. 10 illustrates exemplary diagrams of a UE with limited transmission bandwidth to perform transmission bandwidth hopping within and outside BWP when the first frequency position is different from the frequency position of the uplink BWP in accordance with embodiments of the current invention. In one embodiment, the start frequency of the first SRS transmission is the lowest subcarrier of the lowest RB of a carrier regardless of the uplink BWP. The RedCap UE has a UE UL BWP 1011, which is not at the lowest subcarrier of the lowest RB of the carrier. The start frequency of the first SRS transmission 1001 is adjusted to lowest subcarrier of the lowest RB of carrier 1032. In one embodiment, additional RF retuning time 1031 is added at the start of the SRS transmission when the SRS starts from the lowest RB index that is outside the UE UL BWP. Multiple SRS resources, with SRS resource duration 1012. In one embodiment, as shown, the SRS resource has the same bandwidth as the UE UL BWP 1011. In another embodiment (not shown), similar to FIG. 9, the SRS resources has different bandwidth than the UE UL BWP 1011. The UE is configured with multiple SRS resources and performs frequency hopping 1001, 1002, 1003, 1004 and 1005. There exists partial overlapping BW 1013 in frequency domain between two transmissions to allow the system with base station to estimate the phase change due to RF retuning of UE. The SRS transmissions (1001, 1002, 1003, and 1004) in different time instances may have different frequency positions (e.g., center frequency, start frequency) by RF re-tuning, with a RF retuning time for hopping 1014. In one embodiment, additional RF retuning time is added at the start of the SRS transmission when the SRS bandwidth is different from the UE UL BWP 1011. Once the UE completes the hopping cycle that covers the large bandwidth of the system, at step 1021, the UE returns to the original BWP. A RF retuning time 1022 is configured for RF tuning back to the UE BWP. The UE performs other transmissions 1006 at its original BWP. The SRS frequency hopping will exceed UE's uplink BWP 1011 during the hopping cycle. The network defines a period of time (duration 1015) for UE to transmit outside BWP. The period of time includes all SRS resource durations and RF retuning time required in a complete hopping cycle, and the RF retuning time includes the time back to original uplink BWP as shown at step 1021. In one embodiment, duration 1015 further includes the additional RF retuning time in the beginning to adjust the bandwidth.

In one embodiment, If UE is configured for SRS transmission in frequency hopping manner, the UE is not expected the uplink data scheduling during the hopping duration. If the uplink data scheduling and SRS transmission happen simultaneously, the UE is not expected to transmit SRS outside the active UL BWP. The NW may also configure/re-configure the UE whether to perform frequency hopping outside the active UL BWP or not. The SRS configuration further comprises the spatial relation across several transmissions, the SRS transmissions may be associated to a same downlink RS or an SRS resource for the spatial relation measurement. In another embodiment, the SRS transmission is aborted completely or partial to avoid one or more qualified colliding transmission based on one or predefined rules for SRS dropping. The one or more predefined rules include dropping the SRS frequency hopping transmission within an SRS duration when detecting one or more qualified colliding transmission including data transmission or RS transmission of higher priority within the SRS duration. The Partial SRS transmission abortion happens when the SRS hopping transmission with multiple consecutive slots drops only one or more slots with collision, while the non-colliding SRS transmission continues. In one embodiment, transmission abortion is at the slot level. The stopping of UL SRS transmission is enabled when a time difference is larger than a predefined threshold, and wherein the time difference is between a starting time of the UL SRS transmission and a receiving time when the UE receives an indication of the one or more qualified colliding transmissions.

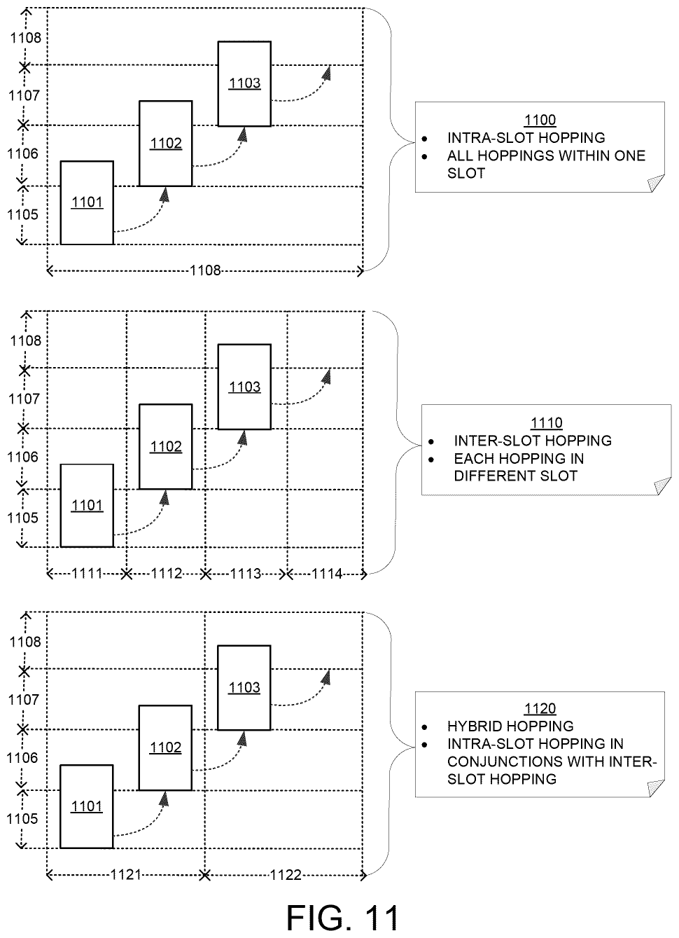

FIG. 11 illustrates exemplary diagrams of a UE with limited transmission bandwidth performing transmission hopping with different hopping configurations in accordance with embodiments of the current invention. In one embodiment, based on the number of OFDM symbols within a slot of each SRS resource transmission, the UE can perform SRS frequency hopping by intra-slot hopping (1100), inter-slot hopping (1110), or intra-slot hopping in conjunction with inter-slot hopping (1120), the time gap between two SRS transmissions should be sufficient for UE to perform RF retuning. As shown, three exemplary frequency hopping 1101, 1102, and 1103 are performed for the UL SRS. Each SRS resource is configured across subcarrier band #0 1105, #1 1106, #2 1107, and #3 1108. In the first configuration 1100 with intra-slot hopping only, SRS 1101, 1102, and 1103 are all performed within one time slot 1108. In the second configuration with inter-slot hopping only, SRS 1101, 1102, and 1103, each hopping transmission transmits in different time slots, namely 1111, 1112, and 1113, respectively. In another embodiment 1120 with hybrid hopping, SRS 1101, 1102, and 113, two hopping transmissions 1101 and 1102 are transmitted in slot 1121 with intra-slot hopping, while SRS 1103 is transmitted in slot 1122 with inter-slot hopping.

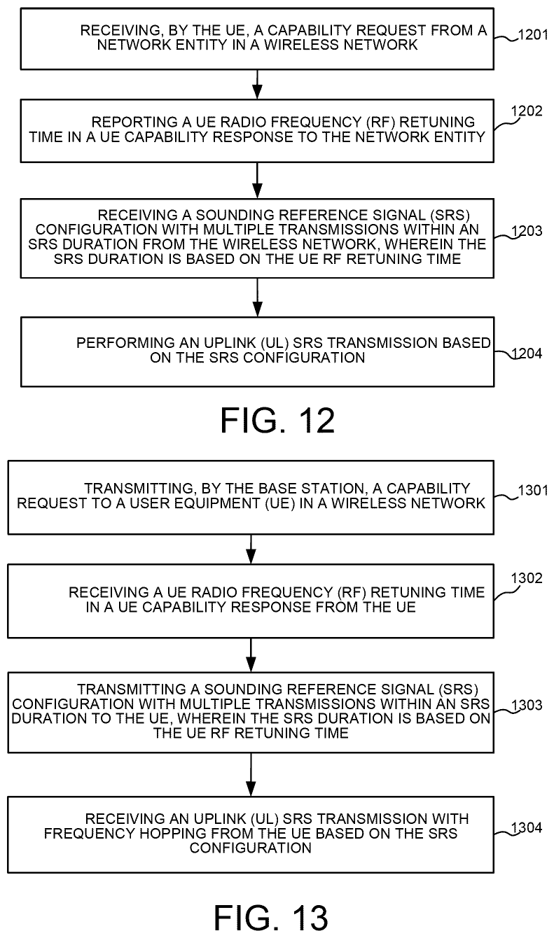

FIG. 12 illustrates an exemplary flow chart for the RedCap UE to perform SRS with frequency hopping for large bandwidth SRS in accordance with embodiments of the current invention. At step 1201, the UE receives a capability request from a network entity in a wireless network. At step 1202, the UE reports a UE radio frequency (RF) retuning time in a UE capability response to the network entity. At step 1203, the UE receives a sounding reference signal (SRS) configuration with multiple transmissions within an SRS duration from the wireless network, wherein the SRS duration is based on the UE RF retuning time. At step 1204, the UE performs an uplink (UL) SRS transmission based on the SRS configuration.

FIG. 13 illustrates an exemplary flow chart for the base station to configure and transmit PRS for RedCap UE for large bandwidth SRS in accordance with embodiments of the current invention. At step 1301, the base station transmits capability request to a user equipment (UE) in a wireless network. At step 1302, the base station receives a UE radio frequency (RF) retuning time in a UE capability response from the UE. At step 1303, the base station transmits a sounding reference signal (SRS) configuration with multiple transmissions within an SRS duration to the UE, wherein the SRS duration is based on the UE RF retuning time. At step 1304, the base station receives an uplink (UL) SRS transmission with frequency hopping from the UE based on the SRS configuration.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method of a user equipment (UE), comprising:
receiving, by the UE, a capability request from a network entity in a wireless network;
reporting a UE radio frequency (RF) retuning time in a UE capability response to the network entity;
receiving a sounding reference signal (SRS) configuration with multiple transmissions within an SRS duration from the wireless network, wherein the SRS duration is based on the UE RF retuning time; and
performing an uplink (UL) SRS transmission based on the SRS configuration.

2. The method of claim 1, wherein the network entity is a base station in the wireless network.

3. The method of claim 1, wherein the network entity is a location management (LMF) at core network of the wireless network.

4. The method of claim 1, wherein each transmission includes SRS in consecutive symbols and each transmission is associated with a lowest resource block (RB) index.

5. The method of claim 1, wherein the SRS configuration includes one or more SRS elements comprising a transmission bandwidth of the SRS, a lowest resource block (RB) location for the SRS transmission, a number of SRS symbols, a relative resource element (RE) offset configuration for corresponding SRS symbols, a number of transmissions within the SRS duration, and a starting OFDM symbol index for corresponding transmission.

6. The method of claim 1, wherein adjacent transmissions have overlapping in a frequency domain.

7. The method of claim 1, wherein an SRS resource set is configured including all transmissions within the SRS duration.

8. The method of claim 7, wherein one or more SRS resources in the SRS resource set are associated with a same downlink spatial relation reference signal (RS).

9. The method of claim 7, wherein the SRS resource set is configured to be periodic, semi-persistent or aperiodic transmission for the one or more SRS resources.

10. The method of claim 1, wherein each time gap between adjacent transmissions is greater than or equal to the UE RF retuning time reported in the UE capability response.

11. The method of claim 1, further comprising stopping the UL SRS transmission on one or more SRS resources to avoid one or more qualified colliding transmissions based on one or more predefined rules.

12. The method of claim 11, wherein the one or more predefined rules comprise dropping the UL SRS transmission within an SRS duration when detecting one or more qualified colliding transmission including data transmission or RS transmission of higher priority within the SRS duration.

13. The method of claim 11, wherein the one or more predefined rules comprise the UL SRS transmission with multiple consecutive slots drops only one or more slots with collision.

14. The method of claim 11, wherein the stopping of the UL SRS transmission is enabled when a time difference is larger than a predefined threshold, and wherein the time difference is between a starting time of the UL SRS transmission and a receiving time when the UE receives an indication of the one or more qualified colliding transmissions.

15. A method of a base station, comprising:
transmitting, by the base station, a capability request to a user equipment (UE) in a wireless network;
receiving a UE radio frequency (RF) retuning time in a UE capability response from the UE;
transmitting a sounding reference signal (SRS) configuration with multiple transmissions within an SRS duration to the UE, wherein the SRS duration is based on the UE RF retuning time; and
receiving an uplink (UL) SRS transmission with frequency hopping from the UE based on the SRS configuration.

16. The method of claim 15, wherein each transmission includes SRS in consecutive symbols and each transmission is associated with a lowest resource block (RB) index.

17. The method of claim 15, wherein the SRS configuration includes one or more SRS elements comprising a transmission bandwidth of the SRS, a lowest resource block (RB) location for the SRS transmission, a number of SRS symbols, a relative resource element (RE) offset configuration for corresponding SRS symbols, a number of transmissions within the SRS duration, and a starting OFDM symbol index for corresponding transmission.

18. The method of claim 15, wherein adjacent transmissions have overlapping in a frequency domain.

19. The method of claim 15, wherein an SRS resource set is configured including all transmissions within the SRS duration.

20. The method of claim 19, wherein one or more SRS resources in the SRS resource set is associated with a same downlink spatial relation reference signal (RS).
